(19) United States
(12) Patent Application Publication
(10) Pub. No.: US 2021/0231217 A1
(43) Pub. Date: Jul. 29, 2021

(54) Shaft Seal Arrangement

(71) Applicant: KSB SE & CO. KGaA, Frankenthal (DE)

(72) Inventor: Markus PITTROFF, Frankenthal (DE)

(21) Appl. No.: 17/059,990

(22) PCT Filed: May 29, 2019
(86) PCT No.: PCT/EP2019/063980

§ 371 Date: Nov. 30, 2020

(30) Foreign Application Priority Data
May 30, 2018 (DE) 10 2018 208 574.9

(51) Int. Cl. F16J 15/34; F16J 15/32

(52) U.S. Cl. CPC F16J 15/34; F16J 15/32

(57) ABSTRACT

A shaft seal arrangement includes a slip-ring seal and a secondary seal. The adjacent seal has at least one O-ring. The O-ring is arranged so as to be axially displaceable. Between the O-ring and a seal element which forms an axial sliding surface for the O-ring, there is arranged a carbon layer to increase the mobility of the O-ring.

The invention relates to a shaft seal arrangement having a mechanical seal and a secondary seal which has at least one O-ring which is arranged so as to be axially displaceable.

Such shaft seal arrangements are used, for example, in centrifugal pumps, at the feedthrough of the rotating shaft from the pump casing.

In mechanical seals, elements such as, for example, shaft sleeves are used to protect the shaft against wear, such elements are therefore also referred to as shaft protecting sleeves. If wear phenomena occur, then only the significantly less expensive shaft sleeve has to be changed, and not the entire shaft.

The shaft sleeve can be manufactured from a higher-quality material which is more resistant to wear and corrosion. This saves costs compared to producing the entire shaft from that material. It is further known to coat shaft sleeves with an oxide ceramics.

The shaft seal arrangement of the generic type comprises a mechanical seal. Mechanical seals have a sealing gap which is generally positioned at a right angle to the shaft axis. Shaft seals of this type are also referred to as axial or hydrodynamic mechanical seals (GLRD). Such mechanical seals (GLRD) have a lower maintenance outlay compared to other sealing systems. They are effective where the pressures or circumferential speeds to be sealed are both low and high.

During operation, seal faces, which are pressed together by hydraulic and/or mechanical forces, slide on one another. Between these two precisely machined slide faces there is a sealing gap with a mostly liquid lubricating film. In the case of mechanical seals (GLRD), the small amount of leakage, when it emerges, in most cases passes into the atmosphere.

The shaft seal arrangement additionally has a sliding secondary seal. The mutually opposite axial or radial seal faces rotate relative to one another and form a primary sealing gap. Between the seal faces, the surrounding medium produces a liquid or gaseous lubricating film, depending on the state of aggregation. Sealing of the mechanical seal parts with respect to the shaft or casing generally takes place by means of secondary seals.

The secondary seal comprises at least one O-ring. Owing to its preferably circular cross-section, the O-ring is able to seal both axially and radially. As a result of the compression of the resilient body on fitting, an initial sealing performance is established. The sealing pressure is given by the superposition of the preliminary pressure due to fitting and the system pressure to be sealed. The sealing pressure prevailing in the sealing gap is therefore always higher than the pressure to be sealed by the preliminary pressure. Very high pressures can therefore be sealed.

When O-rings with constantly moving parts are used, the service life can be lengthened significantly by lubrication. A lubricant in finely divided form is sometimes added to the starting material during production of the sealing ring, which lubricant is able to reach the loaded surface during use through pores in the material structure.

Alternatively, special wear-resistant layers can be applied to the finished O-rings, which layers ensure lubrication for a certain time. A lubricant can also be applied to the O-ring and to the workpiece that slides along the ring on mounting and later renewed at appropriate maintenance intervals. Special mounting greases are supplied for this purpose, which are compatible with most of the sealing materials that are used.

In DE 199 28 141 A1 there is described a seal arrangement in which O-rings are used as secondary seals. The arrangement comprises a shaft sleeve on which there are positioned mechanical seals having a rotating element and a stationary element between which a sealing gap for a lubricant film is arranged.

DE 202 05 419 U1 describes a mechanical seal arrangement having a pair of cooperating elements, of which one is non-rotatably mounted on a stationary component and the other is mounted for joint rotation on a rotating component. A pair comprises a shaft sleeve for joint rotation with the shaft, on which a first element is arranged. The first element cooperates with a second element, which is held non-rotatably on the casing.

In DE 298 00 616 U1 there is described a double mechanical seal. A dynamic primary ring is fastened to a shaft sleeve arranged on a shaft.

WO 95/14 185 A1 discloses a special mechanical seal for sealing a shaft which passes through a casing. A mating ring is fastened to a shaft sleeve. A primary ring can be connected tightly to the casing via a mount. The arrangement has a spring element for pressing the primary ring against the mating ring.

In DE 10 2014 214 929 A1 there is described an arrangement for the shaft sealing of a centrifugal pump unit, which has O-rings as secondary seals and a shaft sleeve. The arrangement comprises a module which has two primary ring/mating ring pairs. Each pair has associated spring elements which generate contact pressures between the primary ring and the mating ring.

The secondary rings used in shaft seal arrangements should permit smooth axial movability of the primary ring. This requirement is fulfilled only unsatisfactorily in conventional shaft seal arrangements according to the prior art.

When O-rings are used as secondary seals, they frequently adhere strongly to their mating slide face after a prolonged rest period. The static friction coefficient of the O-rings can increase considerably over time. If, in the case of a pump seal, the shaft shifts axially after stopping, for example as a result of thermal expansion, only the spring force is available for repositioning the primary ring. The usual spring pressure of the mechanical seal may in this case be too small to break loose the O-ring. The O-ring then “hangs up”, the sealing gap opens, and considerable leakage occurs.

The axial movability of the primary ring is also impeded if a layer of product builds up in front of the secondary seal or if the adjacent face becomes rough as a result of corrosion. If such conditions are to be expected, the primary ring should be so arranged that the spring moves the O-ring away from the rough layer. However, if the layer ultimately reaches beneath the O-ring, leakage must be expected.

A distinction is made in practice between unbalanced and balanced mechanical seals. In balanced mechanical seals, the shoulder necessary for balancing can be provided by a shaft sleeve, on which the O-ring secondary seal is able to slip axially. The seal can fail if the seal faces are bonded together on start-up.

If the mating ring is mounted in an O-ring, a form-fitting anti-twist means is sometimes omitted, in the hope that the static friction of the O-ring will transmit the friction torque. This can work in some cases. However, the utmost caution should be exercised if tacky products are expected to enter the sealing gap or if the mechanical seal faces are expected to adhere to one another as a result of contact corrosion. On re-starting, the mating ring is then carried along too, the O-ring suddenly becomes the rotating seal and as a result is destroyed within a short time.

The object of the invention is to provide an arrangement for shaft sealing which has as small an amount of leakage as possible and a long service life. The arrangement is to be distinguished by high reliability. In addition, it is to ensure simple mounting and also be easily accessible for maintenance work. Furthermore, the arrangement is to be distinguished by production costs that are as low as possible.

According to the invention, a carbon layer is arranged in the secondary seal between the axially displaceable O-ring and an element which forms an axial slide face for the O-ring. Carbon layers are understood as being layers in which carbon is the predominant constituent. The carbon layer can be applied, for example, by a PVD (physical vapor deposition, for example by vaporization or sputtering) or a CVD (chemical vapor deposition) method.

The carbon layer is preferably an amorphous carbon layer, in particular a tetrahedral hydrogen-free amorphous carbon layer, which is also referred to as a ta-C layer.

The atomic bonds (in each case 3 in total) belonging to the crystal lattice of graphite are denoted “sp2”. An sp2-hybridization is thereby present.

In the case of diamond, each carbon atom forms a tetrahedral arrangement with four adjacent atoms. In this spatial arrangement, all the inter-atomic distances are equally small. Very high binding forces therefore act between the atoms, in all spatial directions. This results in the high strength and extreme hardness of diamond. The atomic bonds, in each case four in total, belonging to the crystal lattice of diamond are denoted “sp3”. Accordingly, an sp3-hybridization is present.

In a particularly advantageous variant of the invention, the carbon layer consists of a mixture of sp3- and sp2-hybridized carbon. This layer is characterized by an amorphous structure. Foreign atoms such as hydrogen, silicon, tungsten or fluorine can also be incorporated into this carbon network.

The arrangement according to the invention of a carbon layer results in considerably better axial movability of the O-ring. As a result, the O-rings are prevented from adhering to their mating slide face even after a prolonged rest period. As a result of the carbon layer, the sliding ability of the O-ring is increased to such an extent that the usual spring pressure of the mechanical seal is always sufficient to break loose the O-ring. A “hang-up” is effectively prevented. As a result, leakages are avoided and the service life of the shaft seal arrangement increases considerably. Expensive maintenance work for replacing the O-rings is no longer necessary. This reduces the operating costs.

By the arrangement of a carbon layer between the O-ring of the secondary seal and the element, an extremely smooth axial surface with anti-adhesion properties is provided for the axially movable O-ring, without the need for complex mechanical post-treatment of the components. Accordingly, the shaft seal arrangement according to the invention is distinguished by comparatively low production costs.

The ta-c layer can optionally also be polished in order to obtain an Ra value equal to/less than 0.1.

The carbon layer ensures a lower mechanical load on the dynamic O-ring. As a result of the arrangement according to the invention of the carbon layer, the O-ring does not stick, as is the case with conventional machined elements in the form of shaft sleeves at the small points of a ground surface.

The arrangement according to the invention of a carbon layer between the O-ring and the element makes possible the use of very high-quality O-rings of materials such as, for example, perfluoroelastomers. This was hitherto not possible in the case of conventional shaft seals without relatively great expense, since the surface of the element was not sufficiently smooth without further post-treatment.

By using such high-quality O-rings, a longer service life is achieved, which has a cost-saving effect. In particular when using aggressive chemicals or high temperatures, high-quality O-rings, for example perfluoroelastomers (FFKM/FFPM), are found to be extremely advantageous. Seals of perfluoroelastomers are distinguished by excellent resistance to chemicals and at the same time have the sealing and recovery properties, and also the creep resistance, of elastomers.

The invention also makes possible the use of O-rings of polytetrafluoroethylene (abbreviation PTFE). PTFE is an unbranched, linear, semi-crystalline polymer of fluorine and carbon. Colloquially, this plastics material is often referred to by the trade name “Teflon”. Since it is not an elastomer, the use of such O-rings in conventional seal systems frequently resulted in leakages at the dynamic O-ring, since it did not conform to the small irregularities of the previous coating. The smoother surface resulting from the carbon layer with anti-adhesion properties permits a better sliding behavior and accordingly the use of PTFE O-rings. This also brings advantages due to the considerable price advantage of PTFE O-rings as compared with FFKM/FFPM.

The element which forms an axial slide face for the axially displaceable O-ring can be a shaft sleeve. In addition or alternatively, the element can be configured as a mechanical seal carrier and/or as a seal cover.

In a particularly advantageous variant of the invention, the carbon layer is applied in the form of a coating to the element. The thickness of the layer is advantageously more than 0.3 preferably more than 0.6 in particular more than 0.9 It is further found to be advantageous if the coating is less than 30 μm, preferably less than 25 μm, in particular less than 20 μm.

In a variant of the invention, the element, preferably a normal standard shaft sleeve (serial part), is covered by means of a simple masking device which consists substantially of two tubular parts, in order to expose only the desired coating region. A plurality of elements can thereby be introduced simultaneously into the coating reactor (vacuum chamber), where a ta-C coating is applied with a moderate thermal load.

After the coating operation, the element is ready for use immediately without any post-treatment. The ta-C coating has a very low coefficient of friction while at the same time having very good chemical resistance. The hardness of the coating is very similar to the hardness of diamond, wherein the hardness is preferably more than 20 GPa, preferably more than 30 GPa, in particular more than 40 GPa, but less than 120 GPa, preferably less than 110 GPa, in particular less than 100 GPa.

Preferably, the carbon layer is not applied directly to the element, but an adhesion promoter layer is first provided on the element. The adhesion promoter layer preferably consists of a material which both adheres well to steel and prevents carbon diffusion, for example by the formation of stable carbides. There are used as adhesion-promoting layers which meet these requirements preferably thin layers of chromium, titanium or silicon. In particular, chromium and tungsten carbide have proved to be effective as adhesion promoters.

In an advantageous variant of the invention, the coating has an adhesion promoter layer which preferably comprises a chromium material. Preferably, the adhesion promoter layer consists of more than 30% by weight, preferably more than 60% by weight, in particular more than 90% by weight chromium.

It is found to be advantageous if the thickness of the adhesion promoter layer is more than 0.03 μm, preferably more than 0.06 μm, in particular more than 0.09 μm and/or is less than 0.21 μm, preferably less than 0.18 μm, in particular less than 0.15 μm.

In contrast to the expensive conventional coatings of elements which are configured, for example, as shaft protecting sleeves by means of thermally applied oxide ceramics, the coating technique according to the invention is found to be extremely advantageous. In conventional methods of coating elements, thermal spraying is required. For that purpose, a trough-like recess is required in the region where the coating is to be applied. Machining by finish-turning of all dimensions and circular grinding with subsequent lapping of the outside diameter is then necessary in order to obtain the desired dimension and surface quality.

In the prior art, Stellite hardfacing is also known as a coating method for elements, in particular for shaft sleeves, or galvanic hard chrome plating. However, the Stellite hardfacing and the hard chrome plating are substantially softer than a thermally applied oxide ceramics coating or a ta-C coating.

Accordingly, ta-C coating according to the invention is a simpler, quicker and more economical method. The coating according to the invention, in addition to having very high hardness, also has excellent sliding properties and good chemical resistance. This means ideal conditions for the dynamic O-ring of various mechanical seal types.

In principle, the invention can be used in a conventional single mechanical seal and also in cartridge mechanical seals.

In addition, the invention also makes possible the coating of thin-walled elements with relatively small diameters, which hitherto could be achieved with conventional oxide ceramics coatings only with great difficulty.

The advantage of the higher hardness as a result of the ta-C coating is due on the one hand to the fact that small solids particles, which are often contained in the media, accumulate in the region of the O-ring at which it is in contact with the element. As a result of the axial movement, these solids particles act like an abrasive and thus work their way into the surface of the element. This has the result that small longitudinal grooves form on the surface of conventional elements configured as shaft sleeves and on the surface of the O-ring, which grooves prematurely result in wear of both parts and in leakage.

Preferably, PECVD/PACVD methods are used for the coating. In such methods, plasma excitation of the vapor phase is effected by the coupling in of pulsed direct current (“pulsed DC”), medium-frequency (KHz range) or high-frequency (MHz range) power. For reasons of maximized process variability in the case of different workpiece geometries and loading densities, the coupling in of pulsed direct current has additionally proved to be effective.

This technology yields layers into which foreign atoms can also be incorporated if required. The deposition temperatures are typically significantly below 1500° C. Microstructural and dimensional changes of the materials to be coated (metallic, high- and low-alloy stainless steels, etc.) are ruled out.

Further advantages and features of the invention will become apparent from the description of an exemplary embodiment with reference to a drawing, and from the drawing itself.

In the drawing

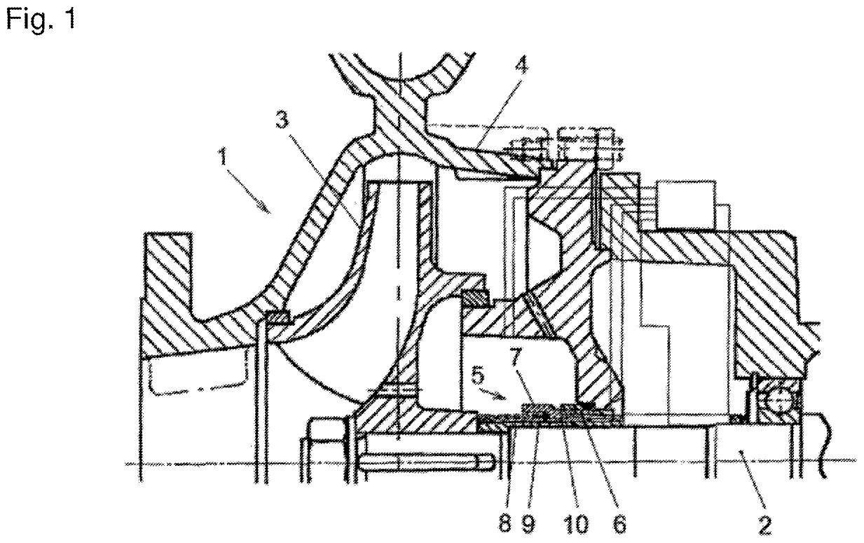

FIG. 1 is a sectional view of a detail of a centrifugal pump,

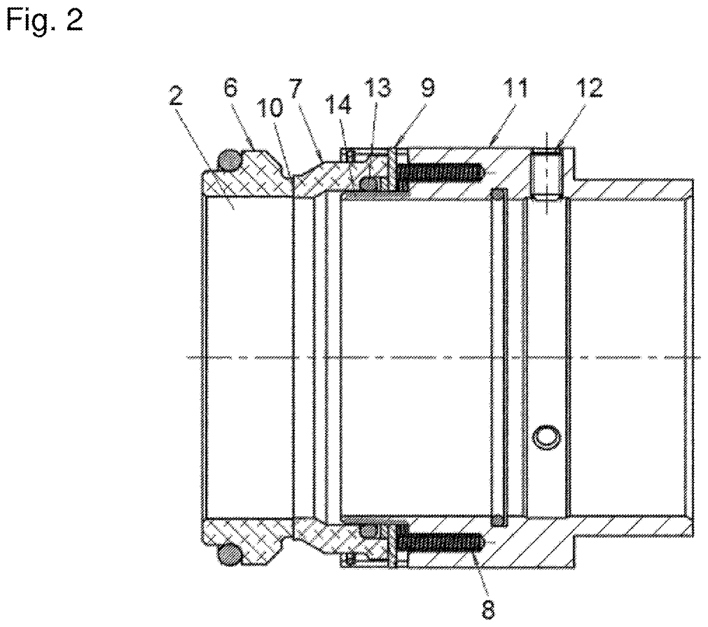

FIG. 2 is an enlarged sectional view arrangement for shaft sealing.

FIG. 1 shows a centrifugal pump 1 having a rotating shaft 2, an impeller 3 and a stationary casing 4. An arrangement for shaft sealing 5 in the form of a mechanical seal comprises a mating ring 6 and an axially movable primary ring 7. The axially movable primary ring 7 is pushed in the direction towards the mating ring 6 by means of a preloading element 8, here a compression spring, and via a support disk 9, so that mutually opposite faces of the mating ring 6 and of the primary ring 7 cooperate in a sealing manner and form a sealing gap 10 between them.

FIG. 2 is an enlarged view of an arrangement for shaft sealing 5. The preloading element 8 exerts a contact pressure on the axially displaceable primary ring 7. On the shaft 2 there is arranged an element 11 configured as a shaft sleeve, which is fixed via a threaded pin 12.

The view according to FIG. 2 shows a plurality of O-rings, of which only the O-ring 13 is arranged so as to be axially displaceable.

According to the invention, a carbon layer 14 is arranged between the axially displaceable O-ring 13 and the element 11 in the form of a shaft sleeve. The carbon layer is introduced into the seal system in the form of an amorphous carbon layer, in particular in the form of a ta-C coating, of the element 11. The thickness of the coating is preferably in the range between 1 and 20 μm, wherein the coating has a chromium-containing 0.1 μm thick adhesion promoter layer between the element 11 and the carbon layer 14.

The coating according to the invention with the carbon layer 14 improves the axial movability of the O-ring 13. As a result, the O-ring 13 is prevented from adhering to a surface even after a prolonged rest period. As a result of the carbon layer 14, the sliding ability of the O-ring 13 is increased to such an extent that the usual spring pressure is sufficient to break loose the O-ring 13. A “hang-up” is thereby prevented.

1-12. (canceled)

13. A shaft seal arrangement, comprising:
a mechanical seal;
a secondary seal having at least one axially-displaceable O-ring;
a seal element, a portion of the seal element having a carbon layer in a region at which the at least one axially-displaceable O-ring is located when the seal element arrangement is in an installed position,
wherein the carbon layer is in contact with the at least one axially-displaceable O-ring.

14. The shaft seal arrangement as claimed in claim 13, wherein the carbon layer is an amorphous carbon layer.

15. The shaft seal arrangement as claimed in claim 14, wherein the carbon layer is a tetrahedral hydrogen-free amorphous carbon layer.

16. The shaft seal arrangement as claimed in claim 15, wherein the carbon layer is an applied coating.

17. The shaft seal arrangement as claimed in claim 16, wherein the coating has an adhesion promoter layer.

18. The shaft seal arrangement as claimed in claim 17, wherein the adhesion promoter layer includes more than 30% by weight of chromium.

19. The shaft seal arrangement as claimed in claim 17, wherein the adhesion promoter layer includes more than 60% by weight of chromium.

20. The shaft seal arrangement as claimed in claim 17, wherein the adhesion promoter layer includes more than 90% by weight of chromium.

21. The shaft seal arrangement as claimed in claim 17, wherein a thickness of the adhesion promoter layer is more than 0.03 μm and less than 0.21 μm.

22. The shaft seal arrangement as claimed in claim 17, wherein a thickness of the adhesion promoter layer is more than 0.06 μm and less than 0.09 μm.

23. The shaft seal arrangement as claimed in claim 17, wherein a thickness of the adhesion promoter layer is more than 0.09 μm and less than 0.15 μm.

24. The shaft seal arrangement as claimed in claim 13, wherein the hardness of the portion of the shaft sleeve having the carbon layer is more than 20 GPa, and less than 120 GPa.

25. The shaft seal arrangement as claimed in claim 13, wherein the hardness of the portion of the shaft sleeve having the carbon layer is more than 30 GPa, and less than 110 GPa.

26. The shaft seal arrangement as claimed in claim 13, wherein the hardness of the portion of the seal element having the carbon layer is more than 40 GPa, and less than 100 GPa.

27. The shaft seal arrangement as claimed in claim 13, wherein the thickness of the carbon layer is more than 0.3 μm and less than 30 μm.

28. The shaft seal arrangement as claimed in claim 13, wherein the thickness of the carbon layer is more than 0.6 μm and less than 25 μm.

29. The shaft seal arrangement as claimed in claim 13, wherein the thickness of the carbon layer is more than 0.9 μm and less than 20 μm.

30. The shaft seal arrangement as claimed in claim 13, wherein the seal element is a shaft sleeve.

31. The shaft seal arrangement as claimed in claim 13, wherein the seal element is as a mechanical seal carrier.

32. The shaft seal arrangement as claimed in claim 13, wherein the seal element is a seal cover.
